(19) United States
(12) Patent Application Publication
(10) Pub. No.: US 2015/0143450 A1
(43) Pub. Date: May 21, 2015

(54) COMPOSITING IMAGES IN A COMPRESSED BITSTREAM

(71) Applicant: Broadcom Corporation, Irvine, CA (US)

(72) Inventors: Jaewon SHIN, Mountain View, CA (US); Brian Francis SCHONER, Fremont, CA (US); Frederick George WALLS, Grafton, WI (US)

(73) Assignee: BROADCOM CORPORATION, Irvine, CA (US)

(21) Appl. No.: 14/147,452

(22) Filed: Jan. 3, 2014

Related U.S. Application Data
(60) Provisional application No. 61/907,365, filed on Nov. 21, 2013.

(51) Int. Cl. H04N 21/44; H04N 21/426; H04N 21/438

(52) U.S. Cl. CPC H04N 21/44004; H04N 21/44016; H04N 21/4382; H04N 21/42692
USPC 725/134

(57) ABSTRACT

A system for compositing images in a compressed bitstream can include memory and first and second modules. The first module can be configured to receive images and corresponding position information that indicates positions of the images in a composite image, determine pixels of the images that will be occluded in the composite image, and store, at memory locations of the memory, pixels of the images that will be visible in the composite image. The second module can be configured to receive the position information, retrieve, from the memory locations, the visible pixels of the images, determine the images corresponding to the visible pixels based at least on the memory locations, and generate the composite image by arranging the visible pixels based at least on the position information. In one or more implementations, the visible pixels can be compressed before being stored in memory and decompressed after being retrieved from memory.

### CROSS-REFERENCE TO RELATED APPLICATIONS

The present application claims the benefit of U.S. Provisional Patent Application Ser. No. 61/907,365, entitled “Compositing Images in a Compressed Bitstream,” filed on Nov. 21, 2013, which is hereby incorporated by reference in its entirety for all purposes.

### TECHNICAL FIELD

The present description relates generally to compositing images, and more particularly, but not exclusively, to compositing images in a compressed bitstream and retrieving the composited images from the compressed bitstream.

### BACKGROUND

Mosaic mode is a feature that can be provided by a set-top device in which multiple decoded images, or portions of images (e.g. sub-images), are displayed simultaneously as a single image, such as in menu selection or in a picture-in-picture arrangement. The multiple decoded images are transmitted to a capture/feeder pipeline that composites the images into a single image for display by an output device, such as a television. The capture/feeder pipeline includes a memory module, such as dynamic random-access memory (DRAM), that facilitates compositing the multiple images into a single image, e.g. to buffer the images while they are being composited. However, in some mosaic modes, such as a picture-in-picture mode, a least a portion of an image can be occluded by another image and therefore the portion will not be visible in the composite image. Furthermore, as image resolutions continue to increase, e.g. 4k, 4k Ultra HD, etc., a significant amount of memory bandwidth, such as DRAM bandwidth, will be used to buffer the multiple images in DRAM for composition into a single image.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a system for compositing images in a compressed bitstream can be implemented in accordance with one or more implementations.

FIG. 2 illustrates an example set-top device implementing a system for compositing images in a compressed bitstream in accordance with one or more implementations.

FIG. 3 illustrates an example composite image in a system for compositing images in a compressed bitstream in accordance with one or more implementations.

FIG. 4 illustrates example position information for an example composite image in a system for compositing images in a compressed bitstream in accordance with one or more implementations.

FIG. 5 illustrates a flow diagram of an example encoding process of a system for compositing images in a compressed bitstream in accordance with one or more implementations.

FIG. 6 illustrates a flow diagram of an example decoding process of a system for compositing images in a compressed bitstream in accordance with one or more implementations.

FIG. 7 illustrates an example output device displaying an example composite image in a system for compositing images in a compressed bitstream in accordance with one or more implementations.

FIG. 8 conceptually illustrates an electronic system with which one or more implementations of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more implementations. In one or more instances, structures and components are shown in block diagram form in order to avoid obscuring the concepts of the subject technology.

In the subject system for compositing images in a compressed bitstream, portions of images that will be occluded in a composite image are determined before the images are stored in DRAM. For example, the subject system can receive position information associated with the images from the application layer, such as coordinates associated with the images, along with an indication of the order in which the images will be layered in the composite image. The subject system can then determine the occluded portions of the images based at least on the received position information. Thus, the subject system can effectively drop the portions of the images that will be occluded, and only store in DRAM the portions of the images that will be visible in the composite image. In this manner, the subject system reduces the DRAM bandwidth used to composite the multiple images into a single image when at least a portion of one of the images is occluded in the composite image. In one or more implementations, the subject system can further encode, e.g. compress, the visible portions of the images when the visible portions of the images are stored in DRAM and can decode, e.g. decompress, the visible portions of the images when the visible portions of the image are retrieved from DRAM. In this manner, the subject system can further reduce the DRAM bandwidth used to composite the images, irrespective of whether any portions of the images are occluded.

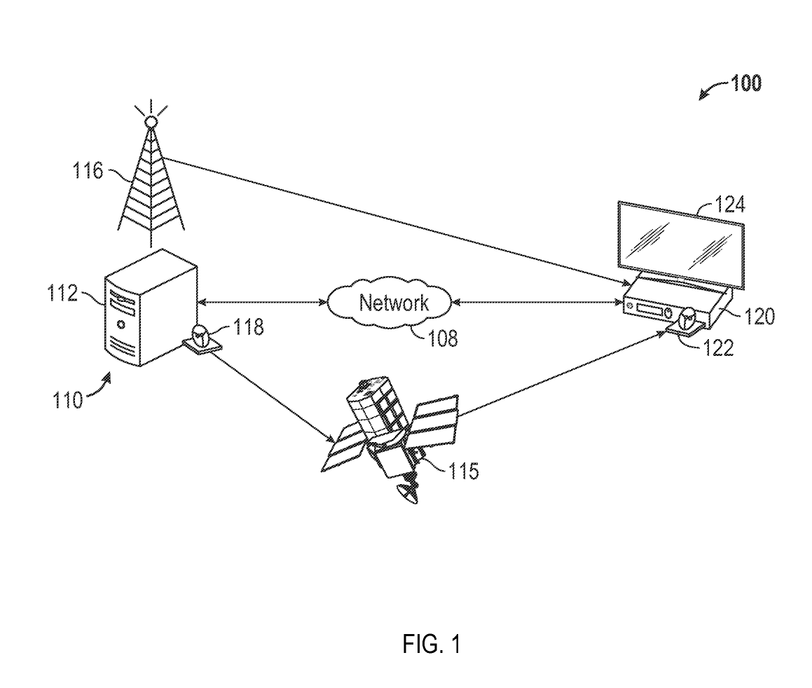

FIG. 1 illustrates an example network environment 100 in which a system for compositing images in a compressed bitstream can be implemented in accordance with one or more implementations. Not all of the depicted components can be used, however, and one or more implementations can include additional components not shown in the figure. Variations in the arrangement and type of the components can be made without departing from the spirit or scope of the claims as set forth herein. Additional components, different components, or fewer components can be provided.

The example network environment 100 includes a content delivery network (CDN) 110 that is communicably coupled to a set-top device 120, such as by a network 108. In one or more implementations, the set-top device 120 can be referred to as a set-top box. The set-top device 120 can be coupled to, and capable of presenting audio video (AV) programs on, an output device 124, such as a television, a monitor, speakers, or any device capable of presenting AV programs. In one or more implementations, the set-top device 120 can be integrated into the output device 124.

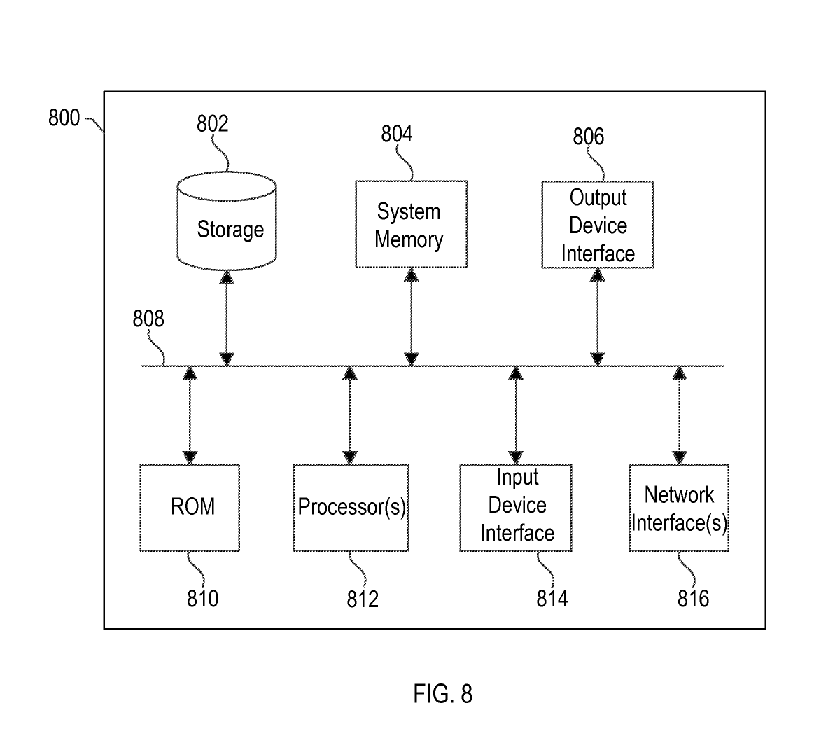

The CDN 110 can include, and/or can be communicably coupled to, a content server 112, an antenna 116 for transmitting AV streams, such as via multiplexed bitstreams, over the air, and a satellite transmitting device 118 that transmits AV streams, such as via multiplexed bitstreams to a satellite 115. The set-top device 120 can include, and/or can be coupled to, a satellite receiving device 122, such as a satellite dish, that receives data streams, such as multiplexed bitstreams, from the satellite 115. In one or more implementations, the set-top device 120 can further include an antenna for receiving data streams, such as multiplexed bitstreams over the air from the antenna 116 of the CDN 110. In one or more implementations, the content server 112 can transmit AV streams to the set-top device 120 over the coaxial transmission network, such as AV streams corresponding to a cable television (CATV) service. In one or more implementations, the set-top device 120 can receive internet protocol (IP) distributed AV streams via the network 108 and native moving picture experts group (MPEG) transport streams can be received via one or more of the antenna 116 and the satellite 115. The set-top device 120 can further include a storage device, such as a hard drive, and the set-top device 120 can retrieve AV streams from the hard drive, e.g. for display on the output device 124. The content server 112 and/or the set-top device 120, can be, or can include, one or more components of the electronic system discussed below with respect to FIG. 8.

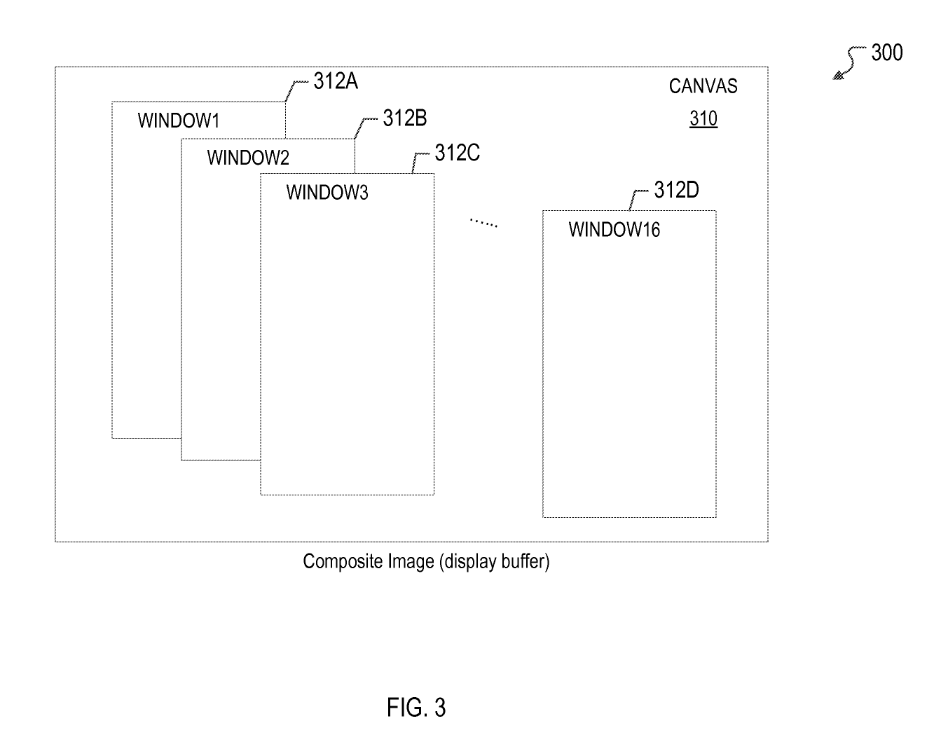

The set-top device 120 can provide video streams, e.g. received via one or more of the aforementioned AV stream sources, for display on the output device 124. The set-top device 120 can composite multiple different video streams into a composite video stream and can provide the composite video stream for display on the output device 124. For example, the set-top device 120 can continuously composite images from multiple video streams, e.g. from multiple different AV stream sources, into a single composite image, and the set-top device 120 can provide a continuous stream of the composite images to the output device 124. In one or more implementations, the set-top device 120 can split a signal received from one of the AV stream sources, such as a signal received over the coaxial transmission network, to obtain multiple video streams from the signal, e.g. for compositing. Example composite images are discussed further below with respect to FIGS. 3, 4, and 7.

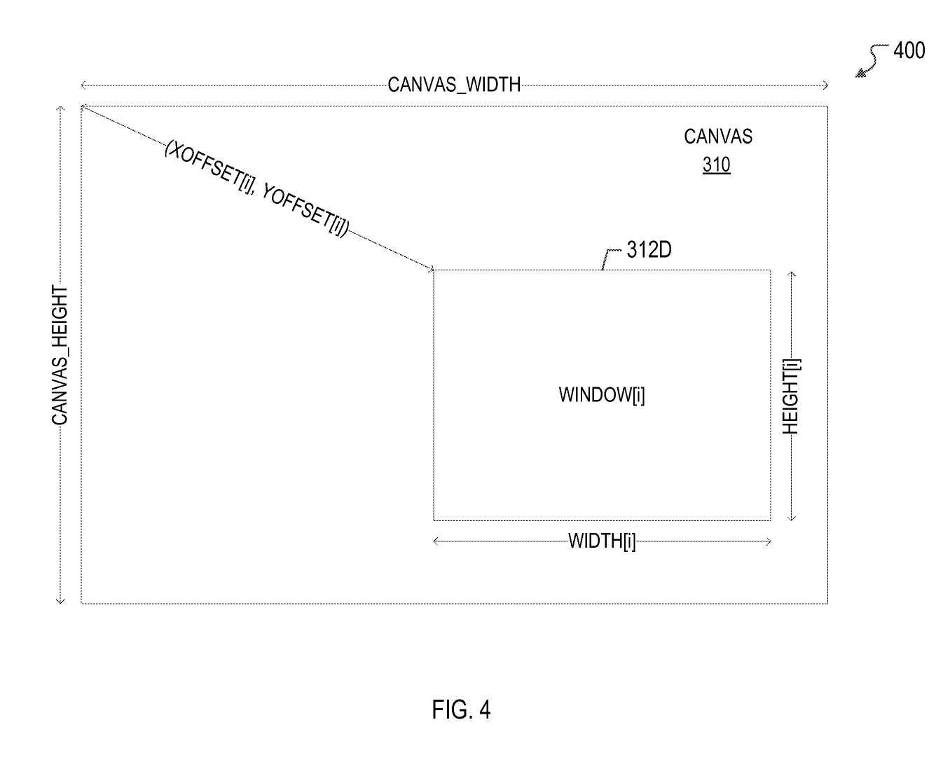

In one or more implementations, the set-top device 120 can buffer the images of the different video streams in a memory, such as DRAM, e.g. to account for frame rate differences, pixel rate differences, or any other differences, amongst the video streams. In one or more implementations, the set-top device 120 can determine whether at least a portion of any of the images will be occluded, e.g. not visible, in the composited image. For example, the set-top device 120 can receive position information that describes the position of each of the images within the composite image, along with an indication of the order in which the images will be layered in the composite image, and the set-top device 120 can determine, based at least on the received position information, whether any portions of any of the images will be occluded. Example position information for an image within a composite image is discussed further below with respect to FIG. 4. If the set-top device 120 determines that any portions of the images will be occluded in the composite image, the set-top device 120 does not store the occluded portions in DRAM, thereby conserving DRAM bandwidth.

In one or more implementations, the set-top device 120 can encode, e.g. compress, the images before storing the images in DRAM, e.g. to conserve DRAM bandwidth. The set-top device 120 can utilize a lightweight encoder to encode the images. An example process of encoding images to be composited is discussed further below with respect to FIG. 3. The set-top device 120 can utilize a lightweight decoder to decode, e.g. decompress, the images as they are retrieved from DRAM to generate the composite image, e.g. in a display buffer. An example process of decoding images is discussed further below with respect to FIG. 4.

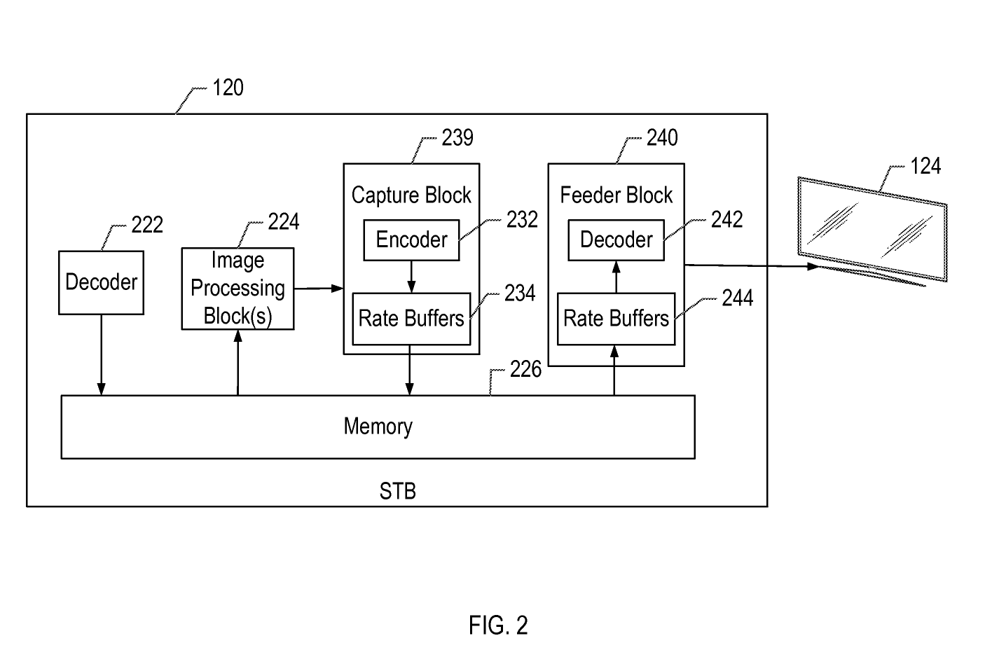

FIG. 2 illustrates an example set-top device 120 implementing a system for compositing images in a compressed bitstream in accordance with one or more implementations. Not all of the depicted components can be used, however, and one or more implementations can include additional components not shown in the figure. Variations in the arrangement and type of the components can be made without departing from the spirit or scope of the claims as set forth herein. Additional components, different components, or fewer components can be provided.

The set-top device 120 can include one or more decoders 222, one or more image processing blocks 224, a capture block 239, a feeder block 240, and a memory 226. The capture block 239 can include an encoder 232 and rate buffers 234. The feeder block 240 can include a decoder 242 and rate buffers 244. In one or more implementations, the rate buffers 234, 244 can be on-chip memory, such as static random-access memory (SRAM), and can be per-image rate buffers 234, 244. For example, the rate buffers 234, 244, can include separate logical buffers allocated to each image being composited, and the capture block 239 and the feeder block 240 can maintain separate context for the individual rate buffers 234, 244. In one or more implementations, the feeder block 240 does not include the rate buffers 244 and/or the capture block 239 does not include the rate buffers 234, such as when a fixed bit rate is used by the encoder 232 and each compression unit is compressed to the same fixed number of bits. In one or more implementations, the memory 226 can be, or can include, DRAM. In one or more implementations, the one or more image processing blocks 224 can include one or more MPEG feeder modules, one or more scaler modules, or generally any image processing blocks or modules.

In operation, the decoder 222 can receive one or more video streams, e.g. from one or more of the AV stream sources. The decoder 222 can decode the video streams and store the decoded video streams in the memory 226. In one or more implementations, the video streams can be already in a decoded format, e.g. a video stream received from a Blu-ray player, and the decoder 222 can be bypassed. The image processing blocks 224 perform image processing on the images of the video streams, e.g. scaling, etc., and provide the processed images to the capture block 239. In one or more implementations, when the images are to be composited into a composite image, the capture block 239 and/or the feeder block 240 can receive position information items and layer indications for each of the images, e.g. from the application layer. For example, the capture block 239 and/or the feeder block 240 can be communicatively coupled to a host processor (not shown) of the set-top device 120 and the host processor can provide the position information items and/or the layer indications to the capture block 239 and/or the feeder block 240.

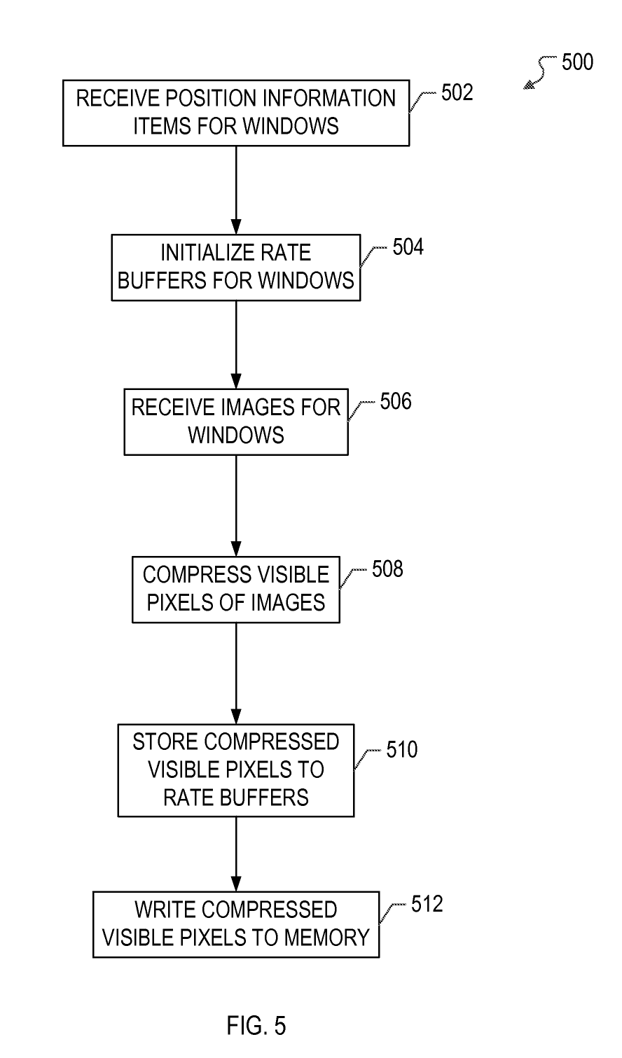

The capture block 239 receives the images and determines the pixels of the images that will be visible, e.g. not occluded, in the composite image. The encoder 232 encodes, e.g. compresses, the pixels of the images that will be visible in the composite image, which can be referred to as the visible pixels of the images, and stores the compressed visible pixels in the per-image rate buffers 234. The capture block 239 then determines a location, e.g. an address, in the memory 226 to write the compressed pixels of each of the images, e.g. based at least on the position information for each of the images, and writes the compressed pixels to the determined locations of the memory 226. An example process of compressing the visible pixels of the images and writing the compressed pixels to the memory 226 is discussed further below with respect to FIG. 5.

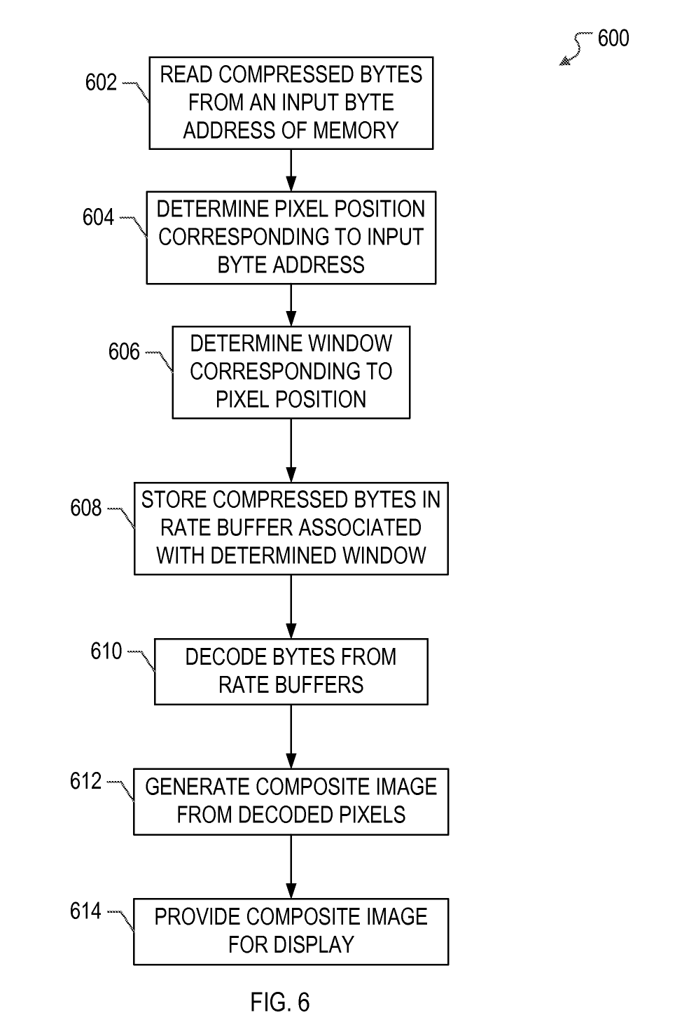

The feeder block 240 retrieves bytes of compressed visible pixels from the memory 226, determines the image that corresponds to the compressed visible pixels, e.g. based at least on the position information and the memory address from which the bytes were retrieved from the memory 226, and stores the compressed visible pixels in the rate buffer 244 associated with the determined image. The feeder block 240 generates the composite image, e.g. line-by-line, by retrieving the appropriate compressed visible pixels from the appropriate rate buffers 244, e.g. based at least on the position information and the layer indications, and decoding, e.g. decompressing, the compressed pixels using the decoder 242. The feeder block 240 can generate the composite image in an on-chip display buffer (not shown) and can provide the composite image to the output device 124, e.g. for display. An example process of decoding the compressed pixels and generating the composite image is discussed further below with respect to FIG. 6.

In one or more implementations, the decoder 222, the image processing blocks 224, the capture block 239, and/or the feeder block 240 can be implemented in software (e.g., subroutines and code). In one or more implementations, the decoder 222, the image processing blocks 224, the capture block 239, and/or the feeder block 240 can be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

FIG. 3 illustrates an example composite image 300 in a system for compositing images in a compressed bitstream in accordance with one or more implementations. Not all of the depicted components can be used, however, and one or more implementations can include additional components not shown in the figure. Variations in the arrangement and type of the components can be made without departing from the spirit or scope of the claims as set forth herein. Additional components, different components, or fewer components can be provided.

The composite image 300 can include a canvas 310 and a number of windows 312A-D. The canvas 310 can encompass the displayable area of the composite image, upon which one or more of the windows 312A-D can be displayed. The windows 312A-D can each display an image, such as images of video streams received from one or more of the AV sources. In one or more implementations, the arrangement, size, and layering of the windows 312A-D within the canvas 310 can be determined at the application level. Thus, the capture block 239 and/or the feeder block 240 can receive parameters and/or variables, e.g. position information items and layer indications, from an application that indicate the arrangement, size, and layering of the windows 312A-D within the canvas 310. An example position information item and layer indication is discussed further below with respect to FIG. 4. In one or more implementations, one or more of the windows 312A-D can occupy the entire canvas 310. In one or more implementations, the composite image 300 can be stored in a display buffer of the set-top device 120, e.g. to provide for presentation on the output device 124.

As shown in FIG. 3, at least a portion of the image of the window 312A is occluded (e.g. covered) in the composite image 300 by the image of the window 312B and the image of the window 312C, and at least a portion of the image of the window 312B is occluded in the composite image 300 by the image of the window 312C. Thus, instead of compressing and storing the entire image of the window 312A and the entire image of the window 312B in the memory 226, the capture block 239 can only compresses and stores in the memory 226 the portion of the image of the window 312A that is not occluded in the composite image 300, and the portion of the image of the window 312B that is not occluded in the composite image 300. In this manner, the amount of bandwidth of the memory 226 that is used to store, and later retrieve, the images of the windows 312A-D can be significantly reduced.

FIG. 4 illustrates example position information for an example composite image 400 in a system for compositing images in a compressed bitstream in accordance with one or more implementations. Not all of the depicted components can be used, however, and one or more implementations can include additional components not shown in the figure. Variations in the arrangement and type of the components can be made without departing from the spirit or scope of the claims as set forth herein. Additional components, different components, or fewer components can be provided.

The example composite image 400 includes the canvas 310 and the window 312D. The canvas 310, and consequently the example composite image 400, has a height of CANVAS_HEIGHT and a width of CANVAS_WIDTH. The index i can be a layer indication that indicates the layer at which the window 312D is displayed in the example composite image 400. For example, the lowest layer window, e.g. the window displayed at the bottom, can be associated with the lowest index value, e.g. 0 or 1, and the highest layer window, e.g. the window at the top for which the displayed image will not be occluded by the images of any other windows, can be associated with the highest index value, e.g. the total number of windows, or the total number of windows minus one.

The position information items corresponding to the window 312D can include the height of the window 312D, e.g. HEIGHT[i], the width of the window 312D, e.g. WIDTH[i], and offset coordinates that indicate the position of the upper left hand corner of the window 312D relative to the upper left hand corner of the canvas 310 (and consequently the example composite image 400), e.g. (XOFFSET[i], YOFFSET[i]). In one or more implementations, the CANVAS_HEIGHT, CANVAS_WIDTH, HEIGHT[i], WIDTH[i], XOFFSET[i], and YOFFSET[i] can each refer to a common unit, such as a number of pixels. In one or more implementations, the CANVAS_HEIGHT, CANVAS_WIDTH, HEIGHT[i], WIDTH[i], XOFFSET[i], and YOFFSET[i] can each be positive values, and/or absolute values. Thus, the size of the window 312D is determinable from the HEIGHT[i] and the WIDTH[i], the position of the window 312D within the canvas 310, and consequently the example composite image 400, is determinable from the coordinate pair of (XOFFSET[i], YOFFSET[i]), and the layer of the window 312D is determinable from the index i.

FIG. 5 illustrates a flow diagram of an example encoding process 500 of a system for compositing images in a compressed bitstream in accordance with one or more implementations. For explanatory purposes, the example encoding process 500 is primarily described herein with reference to the capture block 239 of the set-top device 120 of FIG. 2; however, the example encoding process 500 is not limited to the capture block 239 of the set-top device 120 of FIG. 2, and the example encoding process 500 can be performed by one or more other components of the set-top device 120. Further for explanatory purposes, the blocks of the example encoding process 500 are described herein as occurring in serial, or linearly. However, multiple blocks of the example encoding process 500 can occur in parallel. In addition, the blocks of the example encoding process 500 can be performed a different order than the order shown and/or one or more of the blocks of the example encoding process 500 are not performed.

The capture block 239 receives the position information for the windows 312A-D that will display images within a canvas 310 of a composite image 300 (502). The position information can indicate the sizes of the windows 312A-D, the positioning of the windows 312A-D within the canvas 310 of the composite image 300, and the layering of the windows 312A-D within the canvas 310 of the composite image 300.

The capture block 239 initializes rate buffers 234 for the windows 312A-D (504). As previously discussed, the capture block 239 can allocate a separate rate buffer 234 for each of the windows 312A-D. The rate buffers 234 can each be associated with a rate buffer counter that indicates the amount of free space within each of the rate buffers 234. In one or more implementations, the rate buffer counters can each be initialized as full in order to control the number of bytes written to the memory 226 for a given number of pixels, e.g. in order to ensure that at most 200 bytes are written to the memory 226 (under ½ compression mode) after compressing 100 pixels. In one or more implementations, the ½ compression mode can effectively compress the horizontal width of the images, and consequently the composite image, to half of the original width while maintaining the height of the images. The capture block 239 receives the images to be displayed in each of the windows (506).

In one or more implementations, the rate buffer counters may represent the fullness of the rate buffers 234 of the encoder 232. However, if the rate buffers 244 of the decoder 242 are the same size as the rate buffers 234 of the encoder 232, the rate buffers 244 of the decoder 242 will not overflow and the decoder 242 can operate in real-time. In one or more implementations, with a minor manipulation of the rate control algorithm the rate buffer counters may be used by the decoder 242 to represent the fullness of the rate buffers 244 of the decoder 242 rather than the fullness of the rate buffers 234 of the encoder 232.

The encoder 232 of the capture block 239 compresses the visible pixels of the images of the windows 312A-D, e.g. the non-occluded pixels (508), and stores the compressed non-visible pixels of the images in the rate buffers 234 associated with the windows 312A-D (510). In one or more implementations, the compression used by the encoder 232 to encode the non-occluded pixels of any of the images can utilize a 4×1 block as a compression unit, a 2×1 block as a compression unit, or generally any size block as a compression unit. In one or more implementations, the compression used by the encoder 232 to encode the non-occluded pixels of any of the images can use an 8-bit per pixel (bpp) compression mode, a 10 bpp compression mode, a 12 bpp compression mode, or generally any number of bits per pixel.

In one or more implementations, the encoder 232 can use an algorithm to identify the visible pixels, e.g. non-occluded pixels, of the images. The algorithm can determine, for any pixel position within the canvas 310, the window 312A-D that will be visible, if any. For example, for a given pixel position within the canvas 310, the algorithm can cycle through the windows 312A-D, starting with the lowest layer window and ending with the highest layer window, and can determine the highest layer window that overlaps the pixel position within the canvas 310. In one or more implementations, a window 312A can overlap a given pixel position (x, y) if x is greater than or equal to the XOFFSET for the window 312A and x is less than the XOFFSET plus the WIDTH for the window 312A, and if y is greater than or equal to the YOFFSET for the window 312A and y is less than the YOFFSET plus the HEIGHT of the window 312A.

In one or more implementations, the encoder 232 can utilize a variable bit rate compression algorithm for compressing the pixels of the images. For example, the encoder 232 can use more bits to encode visually complex image areas while using fewer bits to encode visually simple image areas. However, as previously discussed, the encoder 232 can only utilize additional bits for encoding pixels of an images when the additional bits are available in the rate buffer 234 associated with the one of the windows 312A-D corresponding to the image. Since the rate buffers 234 are initialized as being full, the encoder 232 can only be able to utilize additional bits for encoding pixels of an image of a window 312A after the encoder 232 has saved bits encoding pixels of the image of the window 312A, e.g. by using less bits to encode a visually simple area. Thus, the encoder 232 can only use more bits to encode an image of a window 312A after the encoder 232 has saved bits encoding the image of the window 312A, thereby ensuring that the encoding can be stopped at any point and the bits written to the memory 226 will be bounded by the nominal encoding rate multiplied by the number of encoded pixels.

The capture block 239 and/or a component thereof, e.g. the encoder 232, writes the compressed visible pixels of the images to the memory 226 (512). In one or more implementations, the capture block 239 writes the compressed visible pixels to the memory 226 in bursts, such as per line bursts, in order to substantially minimize the number of write accesses to the memory 226. In one or more implementations, the encoder 232 can use a pixel location to memory location mapping to determine a location in the memory 226, e.g. an address, to store the compressed pixels of the images. In this manner, the compressed pixels can be arranged in the memory 226 such that the feeder block 240 can generate the composite image by retrieving and decoding the compressed pixels from the memory 226 using a related memory location to pixel location mapping. The pixel location to memory location mapping, and the memory location to pixel location mapping, can be based at least on the compression mode used by the encoder 232. For example, for a 10 bpp compression mode the ending byte for storing a pixel of an image located at position (x, y) within window 312A identified by the index i, where (x, y) is the actual start location after considering the occlusion from other windows 312B-D and BASE is the first byte used to store any compressed pixels of the composite image, can be determined as:

address=BASE+round [symbol] ((YOFFSET(i)+y)*CANVAS_WIDTH+XOFFSET(i)+x))*5/4 [symbol] (eq.1)

In one or more implementations, the round( ) operation can round decimal or fractional values to the closest integer value. Equation 1 assumes ½ compression of 10-bit 4:2:2 input pixel format (e.g. 5 bytes for 4 pixels). For example, without compression four pixels (4 luma+4 chroma) can use ten bytes in 10-bit 4:2:2 pixel format. In one or more implementations, for a 10 bpp compression mode the ending byte for storing a pixel of an image located at position (x, y) within window 312A identified by the index i, where α is an occlusion factor that indicates how much of the window 312A is occluded, can be determined as:

$$address = BASE + floor ( \frac{WIDTH ( i ) * HEIGHT ( i ) * α}{CANVAS\_WIDTH} ) * CANVAS\_WIDTH * \frac{5}{4} \qquad ( eq . 2 )$$

For a 12 bpp compression mode, the ending byte for storing a pixel of an image located at position (x, y) within window 312A identified by the index i, where BASE is the first byte used to store any compressed pixels of the composite image, can be determined as:

address=BASE+((YOFFSET(i)+y)*CANVAS_WIDTH+(XOFFSET(i)+x))*6/4 (eq. 3)

Since equations 1-3 indicate the ending byte for storing a compressed pixel in the memory 226, the compressed pixel will be stored in the memory 226 before the determined ending byte.

FIG. 6 illustrates a flow diagram of an example decoding process 600 of a system for compositing images in a compressed bitstream in accordance with one or more implementations. For explanatory purposes, the example decoding process 600 is primarily described herein with reference to the feeder block 240 of the set-top device 120 of FIG. 2; however, the example decoding process 600 is not limited to the feeder block 240 of the set-top device 120 of FIG. 2, and the example decoding process 600 can be performed by one or more other components of the set-top device 120. Further for explanatory purposes, the blocks of the example decoding process 600 are described herein as occurring in serial, or linearly. However, multiple blocks of the example decoding process 600 can occur in parallel. In addition, the blocks of the example decoding process 600 can be performed a different order than the order shown and/or one or more of the blocks of the example decoding process 600 are not performed.

The feeder block 240 reads bytes from the memory 226 (602). In one or more implementations, the feeder block 240 reads the bytes from the memory in bursts, such as per line bursts, in order to substantially minimize the number of read accesses to the memory 226. The feeder block 240 determines the pixel position corresponding to the bytes read from the memory 226 (604). For example, the feeder block 240 can utilize a memory location to pixel location mapping to determine the pixel position that corresponds to bytes read from the memory 226. In one or more implementations, the memory location to pixel location mapping can be based at least on the compression mode used by the encoder 232. For example, for a 10 bpp compression mode, the memory location to pixel location mapping for an input_byte_address can be based at least on the following set of equations:

tmp=floor((input_byte_address*4)/5)

y=floor(tmp/CANVAS_WIDTH)

x=tmp−y*CANVAS_WIDTH

For a 12 bpp compression mode, the memory location to pixel location mapping can be based at least on the following set of equations:

tmp=floor((input_byte_address*4)/6)

y=floor(tmp/CANVAS_WIDTH)

x=tmp−y*CANVAS_WIDTH

Once the feeder block 240 determines the pixel position (x, y) mapped to the input byte address, the feeder block 240 determines one of the windows 312A-D, such as the window 312A, for which the displayed image will be visible at the determined pixel position (x, y) (606). For example, the feeder block 240 can cycle through the windows 312A-D, starting with the lowest layer window and ending with the highest layer window, to determine the highest layer window 312A that encompasses the pixel position (x, y). The feeder block 240 then stores the compressed bytes in the rate buffer 244 associated with the determined window (608).

The decoder 242 of the feeder block 240 decodes the compressed bytes from the rate buffers 244 on a line by line basis, e.g. line by line of the composite image, to recover the visible pixels of the images (610). For example, the decoder 242 can decode the compressed bytes from the rate buffers 244 for a given line of the composite image based at least on the positional information items that indicate the positions of the windows 312A-D within the canvas 310. The decoder 242 can maintain separate contexts for each of the rate buffers 244. In one or more implementations, the rate buffers 244 of the decoder 242 may be initialized as empty, e.g. when the rate buffers of 234 of the encoder 232 are initialized as full. The feeder block 240 then generates the composite image from the pixels, e.g. in a display buffer (612). In one or more implementations, the feeder block 240 can fill in any unused pixels of the canvas 310, such as with black pixels. The feeder block 240 provides the composite image for display (614), such as to the output device 124.

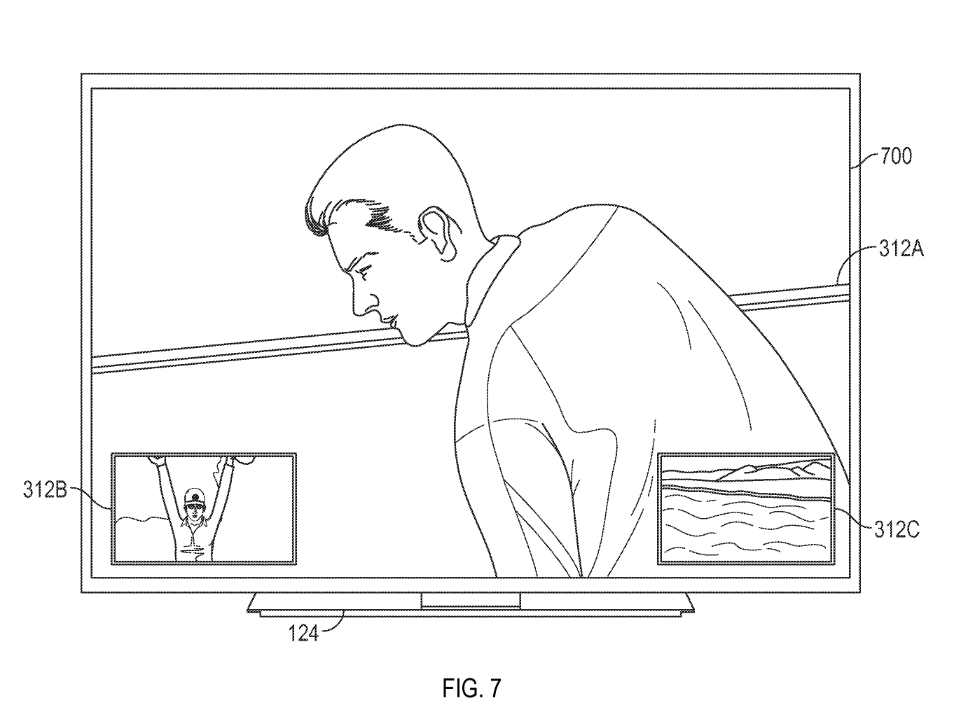

FIG. 7 illustrates an example output device 124 displaying an example composite image 700 in a system for compositing images in a compressed bitstream in accordance with one or more implementations. Not all of the depicted components can be used, however, and one or more implementations can include additional components not shown in the figure. Variations in the arrangement and type of the components can be made without departing from the spirit or scope of the claims as set forth herein. Additional components, different components, or fewer components can be provided.

The example composite image 700 includes images of windows 312A-D. As shown in FIG. 7, the canvas 310 is completely filled by the image of the window 312A. In one or more implementations, the example composite image 700 can be referred to as a picture in picture (PIP) arrangement. That is, the images of the windows 312B-C are displayed within the image of the window 312A. Thus, portions of the image of the window 312A are occluded by the images of the windows 312B-C, but the entire images of the windows 312B-C are visible, or no portions of the images of the windows 312B-C are occluded.

FIG. 8 conceptually illustrates an electronic system 800 with which one or more implementations of the subject technology can be implemented. The electronic system 800, for example, can be a gateway device, a set-top box, a desktop computer, a laptop computer, a tablet computer, a server, a switch, a router, a base station, a receiver, a phone, or generally any electronic device that transmits signals over a network. The electronic system 800 can be, and/or can be a part of, the set-top device 120. Such an electronic system includes various types of computer readable media and interfaces for various other types of computer readable media. The electronic system 800 includes a bus 808, one or more processor(s) 812, a system memory 804 or buffer, a read-only memory (ROM) 810, a permanent storage device 802, an input device interface 814, an output device interface 806, and one or more network interface(s) 816, or subsets and variations thereof.

The bus 808 collectively represents all system, peripheral, and chipset buses that communicatively connect the numerous internal devices of the electronic system 800. In one or more implementations, the bus 808 communicatively connects the one or more processor(s) 812 with the ROM 810, the system memory 804, and the permanent storage device 802. From these various memory units, the one or more processor(s) 812 retrieve instructions to execute and data to process in order to execute the processes of the subject disclosure. The one or more processor(s) 812 can be a single processor or a multi-core processor in different implementations.

The ROM 810 stores static data and instructions that are used by the one or more processor(s) 812 and other modules of the electronic system 800. The permanent storage device 802, on the other hand, can be a read-and-write memory device. The permanent storage device 802 can be a non-volatile memory unit that stores instructions and data even when the electronic system 800 is off. In one or more implementations, a mass-storage device (such as a magnetic or optical disk and its corresponding disk drive) can be used as the permanent storage device 802.

In one or more implementations, a removable storage device (such as a floppy disk, flash drive, and its corresponding disk drive) can be used as the permanent storage device 802. Like the permanent storage device 802, the system memory 804 can be a read-and-write memory device. However, unlike the permanent storage device 802, the system memory 804 can be a volatile read-and-write memory, such as random access memory. The system memory 804 can store any of the instructions and data that one or more processor(s) 812 can use at runtime. In one or more implementations, the processes of the subject disclosure are stored in the system memory 804, the permanent storage device 802, and/or the ROM 810. From these various memory units, the one or more processor(s) 812 retrieve instructions to execute and data to process in order to execute the processes of one or more implementations.

The bus 808 also connects to the input and output device interfaces 814 and 806. The input device interface 814 enables a user to communicate information and select commands to the electronic system 800. Input devices that can be used with the input device interface 814 can include, for example, alphanumeric keyboards and pointing devices (also called “cursor control devices”). The output device interface 806 can enable, for example, the display of images generated by electronic system 800. Output devices that can be used with the output device interface 806 can include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations can include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

As shown in FIG. 8, bus 808 also couples electronic system 800 to one or more networks (not shown) through one or more network interface(s) 816. One or more network interface(s) can include an Ethernet interface, a WiFi interface, a multimedia over coax alliance (MoCA) interface, a reduced gigabit media independent interface (RGMII), or generally any interface for connecting to a network. In this manner, electronic system 800 can be a part of one or more networks of computers (such as a local area network (LAN), a wide area network (WAN), or an Intranet, or a network of networks, such as the Internet. Any or all components of electronic system 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein can be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans can implement the described functionality in varying ways for each particular application. Various components and blocks can be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes can be rearranged, or that all illustrated blocks be performed. Any of the blocks can be performed simultaneously. In one or more implementations, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component can also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect can apply to all configurations, or one or more configurations. An aspect can provide one or more examples of the disclosure. A phrase such as an “aspect” can refer to one or more aspects and vice versa. A phrase such as an “embodiment” does not imply that such embodiment is essential to the subject technology or that such embodiment applies to all configurations of the subject technology. A disclosure relating to an embodiment can apply to all embodiments, or one or more embodiments. An embodiment can provide one or more examples of the disclosure. A phrase such an “embodiment” can refer to one or more embodiments and vice versa. A phrase such as a “configuration” does not imply that such configuration is essential to the subject technology or that such configuration applies to all configurations of the subject technology. A disclosure relating to a configuration can apply to all configurations, or one or more configurations. A configuration can provide one or more examples of the disclosure. A phrase such as a “configuration” can refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method for compositing images in a compressed bitstream, the method comprising:
receiving images and corresponding position information items that indicate positions of the images in a composite image;
determining occluded portions of the images that will be occluded by another of the images in the composite image based at least on the position information items; and
storing, in a memory module, representations of visible portions of the images that will be visible in the composite image, the visible portions of the images being separate from the occluded portions of the images.

2. The method of claim 1, further comprising:
retrieving, from the memory module, the representations of the visible portions of the images; and
generating the composite image from the representations of the visible portions of the images, the visible portions of the images being arranged in the composite image based at least on the position information items; and
providing, for display, the composite image that comprises the visible portions of the images.

3. The method of claim 2, wherein storing, in the memory module, the representations of the visible portions of the images that will visible in the composite image further comprises:
compressing, using a compression algorithm, the representations of the visible portions of the images; and
storing, in the memory module, the compressed representations of the visible portions of the images.

4. The method of claim 3, wherein retrieving, from the memory module, the compressed representations of the visible portions of the images comprises:
retrieving, from memory locations of the memory module, the compressed representations of the visible portions of the images; and
decompressing the compressed representations of the visible portions of the images.

5. The method of claim 4, wherein the compression algorithm comprises a variable bit rate compression algorithm, and the method further comprises:
utilizing independent rate buffers for the images;
retrieving, from the memory locations of the memory module, the compressed representations of the visible portions of the images;
determining the images corresponding to the compressed representations of the visible portions of the images based at least on the memory locations; and
storing the compressed representations of the visible portions of the images in the rate buffers utilized for the images.

6. The method of claim 5, further comprising:
determining the images corresponding to the compressed representations of the visible portions of the images based at least on the memory locations and a memory location to pixel location mapping.

7. The method of claim 3, wherein the compression algorithm comprises a variable bit rate compression algorithm, and the method further comprises:
utilizing independent rate buffers for the images; and
buffering the compressed representations of the visible portions of the images in the corresponding rate buffers prior to storing, in the memory module, the compressed representations of the visible portions of the images.

8. The method of claim 3, wherein the storing, in the memory module, the compressed representations of the visible portions of the images further comprises:
determining locations in the memory module to store the compressed representations of the visible portions of the images based at least on a pixel location to memory location mapping.

9. The method of claim 1, wherein the occluded portions of the images comprise occluded pixels of the images, the visible portions of the images comprise visible pixels of the images, and the memory module comprises dynamic random-access memory.

10. A computer program product comprising instructions stored in a tangible computer-readable storage medium, the instructions comprising:
instructions for receiving position information items that indicate positions of images in a composite image, wherein at least a portion of one of the images is overlapped by another of the images in the composite image;
instructions for retrieving, from memory locations of a memory module, compressed visible portions of the images, the compressed visible portions of the image, when decompressed, being visible in the composite image;
instructions for storing the compressed visible portions of the images in buffers associated with the images corresponding to the compressed visible portions, the images corresponding to the compressed visible portions being determined based at least on the memory locations and the position information items;
instructions for decompressing the compressed visible portions of the images; and
instructions for generating the composite image from the decompressed visible portions of the images, the decompressed visible portions of the images being arranged in the composite image based at least on the position information items.

11. The computer program product of claim 10, wherein the position information items comprise layer indications that are indicative of an order in which the images are layered in the composite image.

12. The computer program product of claim 10, wherein the instructions further comprise:
instructions for determining the images corresponding to the compressed visible portions based at least on a memory location to pixel location mapping.

13. The computer program product of claim 12, wherein the memory location to pixel location mapping is based at least on a compression algorithm used to compress the compressed visible portions of the images.

14. The computer program product of claim 13, wherein the instructions further comprise:
instructions for receiving the images;
instructions for determining occluded portions of the images that will be occluded by another of the images in the composite image based at least on the position information items;
instructions for compressing, using the compression algorithm, the visible portions of the images; and
instructions for storing, at the memory locations of the memory module, the compressed visible portions of the images, the compressed visible portions of the images being separate from the occluded portions of the images.

15. The computer program product of claim 14, wherein the instructions further comprise:
instructions for determining one of the memory locations for storing one of the compressed visible portions of one of the images based at least on the compression algorithm, a position of the one of the compressed visible portions within the one of the images, and the one of the position information items corresponding to the one of the images.

16. A system comprising:
a memory that is configured to store pixels;
a first module that is configured to receive images and corresponding position information items that indicate positions of the images in a composite image, determine occluded pixels of the images that will be occluded by another of the images in the composite image based at least on the position information items, and store, at memory locations of the memory, visible pixels of the images that will be visible in the composite image, the visible pixels of the images being separate from the occluded pixels of the images; and
a second module that is configured to receive the position information items, retrieve, from the memory locations of the memory, the visible pixels of the images, determine the images corresponding to the visible pixels based at least on the memory locations, and generate the composite image from the visible pixels of the images, the visible pixels of the images being arranged in the composite image based at least on the position information items.

17. The system of claim 16, further comprising a host processor and wherein:
the first module is configured to receive the position information items from the host processor; and
the second module is configured to receive the position information items from the host processor.

18. The system of claim 16, wherein:
the first module is configured to compress the visible pixels of the images and store, at the memory locations of the memory, the compressed visible pixels; and
the second module is configured to retrieve, from the memory locations of the memory, the compressed visible pixels, store the compressed visible pixels in buffers associated with the corresponding images, and decompress the compressed visible pixels.

19. The system of claim 18, wherein:
the memory comprises dynamic random access memory;
the first module is configured to store, in first bursts, the compressed visible pixels at the memory locations of the memory; and
the second module is configured to retrieve, in second bursts, the compressed visible pixels from the memory locations of the memory.

20. The system of claim 16, further comprising:
a display buffer that is configured to store the composite image, wherein the second module is configured to write the composite image to the display buffer.
